(19) United States
(12) Patent Application Publication
(10) Pub. No.: US 2007/0240987 A1
(43) Pub. Date: Oct. 18, 2007

(54) Apparatus and Method for Measuring Nitric Oxide in Exhaled Breath

(76) Inventors: Balakrishnan G. Nair, Sandy, UT (US); Jesse Alan Nachias, Salt Lake City, UT (US); Brett Tamatea Henderson, Salt Lake City, UT (US)

Correspondence Address: CERAMATEC, INC., 2425 SOUTH 900 WEST, SALT LAKE CITY, UT, 84119, US

(21) Appl. No.: 11/735,154

(22) Filed: Apr. 13, 2007

Related U.S. Application Data
(60) Provisional application No. 60/792,308, filed on Apr. 14, 2006.

(51) Int. Cl. G01N 27/26

(52) U.S. Cl. 204/426; 422/82.04

(57) ABSTRACT

A sensing apparatus to measure nitric oxide (NO) in exhaled breath is disclosed. An embodiment of the sensing apparatus includes an inlet, a pretreatment element, and a sensing electrode. The inlet is configured to receive the exhaled breath. The pretreatment element is configured to receive the exhaled breath from the inlet and to condition a chemical characteristic of the exhaled breath. The sensing electrode is coupled to a chamber within the sensing apparatus. The chamber is configured to receive the pretreated exhaled breath from the pretreatment element. The sensing electrode is configured to detect a component of nitrogen oxide (NO_{X}) in the exhaled breath.

### CROSS-REFERENCE TO RELATED APPLICATIONS

This application claims the benefit of U.S. Provisional Application No. 60/792,308, filed on Apr. 14, 2006, which is incorporated by reference herein in its entirety.

### BACKGROUND

Asthma is an epidemic in the civilian arena. The incidence of asthma has increased in the United States in recent years and it affects about fifteen million Americans, including almost five million children. Every year, asthma causes over two million emergency room visits, approximately 500,000 hospitalizations, and 4,500 deaths.

Inflammatory disorders such as asthma often cause increased levels of nitric oxide (NO) in exhaled breath. Similarly, the effectiveness of an asthma treatment is frequently evaluated by monitoring increases and decreases of NO in exhaled breath. Thus, NO is often used as an indicator to evaluate patients with asthma or other inflammatory conditions.

Conventional technologies that can be used to detect NO in human breath are NIOX and NIOXMINO available from Aerocrine AB of Sweden. These conventional devices detect NO in human breath using chemiluminescence, which is the emission of light without heat from a chemical reaction. While these conventional devices may detect small quantities of NO in exhaled human breath, the operation of these conventional devices is subject to certain limitations. For example, these conventional devices typically require frequent calibration in order to maintain consistent readings of exhaled NO (eNO). Specifically, some conventional devices are scheduled for calibration every two weeks. Such frequent calibration is typical for devices which use chemiluminescence to detect NO in exhaled breath.

Additionally, there is a significant tradeoff between cost and response time with these conventional devices. While some devices may provide a relatively fast response time, the cost of such technology is cost-prohibitive for individuals. Thus, the most accurate chemiluminescent devices are typically only available for doctor-level monitoring of patient progress on a periodic basis. The cost of this equipment may inhibit wide-spread deployment of the most accurate chemiluminescent technology. In contrast, other chemiluminescent devices are affordable for personal use, but the response time of such technology is too slow.

Additionally, these conventional devices are not suited for use by small children, as well as some older patients, because the technology employed requires a significant amount of exhaled air over a relatively long period. For example, some devices measure the eNO over a plateau period of 3 seconds. In order to maintain such a plateau, the patient may have to exhale consistently over a period of 5-8 seconds, or even up to 10 seconds. Since younger patients and some older patients may have difficulty sustaining this type of exhalation for such a long period of time, the conventional technology is not recommended for use by all patients. Additionally, it should be noted that patients with inflammatory disorders such as asthma often have difficulty with sustained exhalation and may be unable to exhale consistently enough to ensure accurate results using the conventional chemiluminescent technology.

### SUMMARY

Embodiments of an apparatus are described. In one embodiment, the apparatus is a sensing apparatus to measure nitric oxide (NO) in exhaled breath. An embodiment of the sensing apparatus includes an inlet, a pretreatment element, and a sensing electrode. The inlet is configured to receive the exhaled breath. The pretreatment element is configured to receive the exhaled breath from the inlet and to condition a chemical characteristic of the exhaled breath. The sensing electrode is coupled to a chamber within the sensing apparatus. The chamber is configured to receive the pretreated exhaled breath from the pretreatment element. The sensing electrode is configured to detect a component of nitrogen oxide (NO_{X}) in the exhaled breath. Other embodiments of the apparatus are also described.

Embodiments of a method are also described. In one embodiment, the method is a method for measuring NO in exhaled breath. An embodiment of the method includes receiving the exhaled breath, pretreating a chemical characteristic of the exhaled breath, conducting the pretreated exhaled breath to a sensing electrode, and detecting a component of NO_{X} in the exhaled breath. Other embodiments of the method are also described.

Other aspects and advantages of embodiments of the present invention will become apparent from the following detailed description, taken in conjunction with the accompanying drawings, which are illustrated by way of example of the various principles and embodiments of the invention.

### BRIEF DESCRIPTION OF THE DRAWINGS

FIG. 1 depicts a schematic block diagram of one embodiment of a sensing apparatus.

FIG. 2 depicts a schematic block diagram of a more detailed embodiment of the sensing apparatus of FIG. 1.

FIG. 3 depicts a schematic diagram of another embodiment of the sensing apparatus of FIG. 1.

FIG. 4 depicts a schematic diagram of another embodiment of the sensing apparatus of FIG. 1, including a receiver and a conduit to direct the exhaled breath into the inlet of the sensing apparatus.

FIG. 5 depicts a schematic flow chart diagram of one embodiment of a method to determine a level of NO in the exhaled breath by detecting NO in the pretreated exhaled breath.

FIG. 6 depicts a schematic flow chart diagram of one embodiment of a method to determine a level of NO in the exhaled breath by detecting nitrogen dioxide (NO₂) in the pretreated exhaled breath.

FIG. 7 depicts a schematic flow chart diagram of one embodiment of a method to determine a level of NO in the exhaled breath by detecting NO and oxygen in the pretreated exhaled breath.

FIG. 8 depicts a schematic flow chart diagram of one embodiment of a method for user interaction with an embodiment of the sensing apparatus of FIG. 1.

Throughout the description, similar reference numbers may be used to identify similar elements.

### DETAILED DESCRIPTION

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In the following description, numerous specific details are provided, such as examples of housings, barriers, chambers etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations such as vacuum sources are not shown or described in detail to avoid obscuring aspects of the invention.

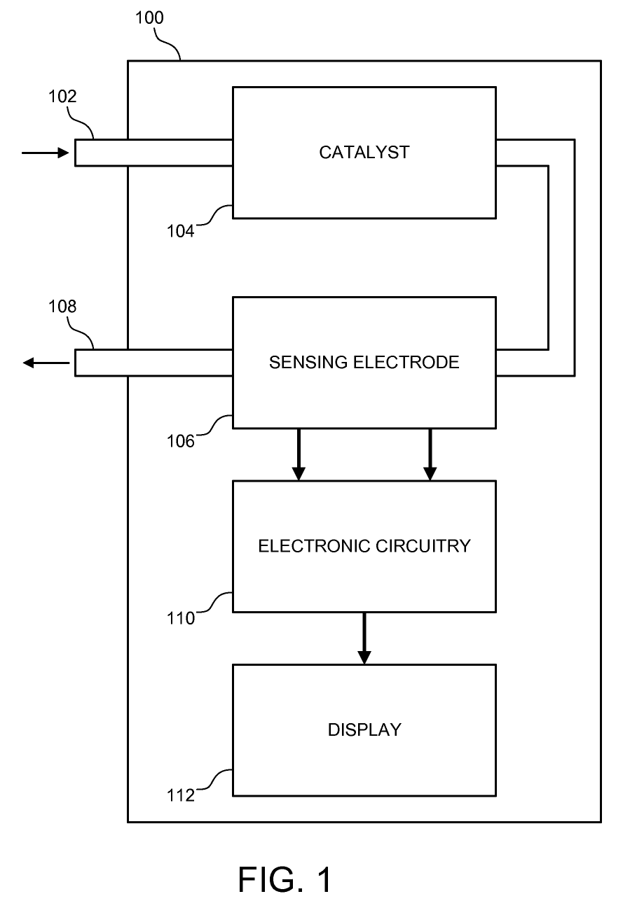

FIG. 1 depicts a schematic block diagram of one embodiment of a sensing apparatus 100. The illustrated sensing apparatus 100 includes an inlet 102, a catalyst 104, a sensing electrode 106, and an outlet 108. The sensing apparatus 100 also includes electronic circuitry 110 and a display device 112. In general, the sensing apparatus 100 is capable of determining if exhaled breath contains an amount or component of nitric oxide (NO), as the exhaled breath passes through or by the inlet 102, the catalyst 104, the sensing electrode 106, and the outlet 108. In some embodiments, the sensing apparatus 100 detects levels of NO as low as ten (10) parts per billion (ppb). Other embodiments of the sensing apparatus 100 detect levels of NO as low as one (1) ppb. In this way, the sensing apparatus 100 may be used by patients on a frequent basis to monitor a variety of respiratory conditions, including asthma.

Additionally, the physical size and weight of the sensing apparatus 100 may vary depending on the implementation. In some embodiments, the sensing apparatus 100 is physically small and light enough to be lifted and carried around by one person. For example, the sensing apparatus 100 may weigh less than ten (10) pounds (lbs). In another example, the sensing apparatus 100 may weight less than two (2) lbs. In regard to size, some embodiments of the sensing apparatus 100 may be less than about 300 cubic centimeters (cc) in volume. Other embodiments of the sensing apparatus are less than about 50 cc, and other embodiments are less than about 20 cc. Still other embodiments may be less than about 5 cc and some less than about 2 cc. Although the size and weight of the sensing apparatus 100 facilitates relatively easy use by individuals, use of the sensing apparatus 100 by a physician for one or more patients is not precluded.

In one embodiment, the catalyst 104 conditions a chemical characteristic of the exhaled breath. In other words, the catalyst 104 pretreats the exhaled breath before it is directed to the sensing electrode 106. There are many types of catalysts 104, or combinations of catalysts 104, that may be implemented. For example, some catalysts 104 change the composition of the exhaled breath in order to minimize cross-sensitivity. Thus, the catalyst 104 may facilitate oxidation of carbon-monoxide (CO) to carbon dioxide (CO₂), oxidation of hydrocarbons to CO₂ and steam (H₂O), absorption of sulfur dioxide (SO₂), and oxidation of ammonia (NH₃) to nitrogen (N₂) and steam (H₂O). For ease of description, these and other forms of catalytic processes may be categorized into four general categories: conversion, oxidation, absorption, and equilibrium. However, it should be noted that embodiments of the catalyst 104 may implement one or a combination of these catalytic processes, and do not necessarily implement all of these catalytic processes.

In one embodiment, the catalyst 104 is an oxidation catalyst such as platinum, ruthenium (IV) oxide (RuO₂) or cobalt oxide (CO₃O₄) which functions to oxidize hydrocarbons and convert CO to CO₂. Other catalysts 104 also may be used such as, for example, the catalysts described and mentioned in U.S. patent application Ser. No. 11/137,693, filed May 25, 2005, and U.S. Provisional Application No. 60/574,622, filed May 26, 2004, both of which are incorporated by reference herein in their entirety. In another embodiment, other pretreatment elements 104 are used to remove unwanted components from the exhaled breath prior to the exhaled breath coming into contact with the sensing electrode 106. For example, the pretreatment element 104 may accept hydrocarbons and CO and yield N₂, O₂, NO, CO₂, and H₂O (e.g., water). As a specific example, the pretreatment element 104 may include an alumina (Al₂O₃) felt. In one embodiment, the pretreatment element 104 such as a catalyst is porous so that the flow of the exhaled breath is not significantly obstructed by the pretreatment element 104. In this way, the sensing apparatus 100 is configured to be effective with just a small volume of exhaled breath over a short amount of time.

After the exhaled breath is pretreated by the catalyst 104 or another pretreatment element, the exhaled breath is then conducted to the sensing electrode 106. In one embodiment, the sensing electrode 106 is a highly sensitive element that detects very low levels (e.g., less than 10 ppb) of NO in the exhaled breath. Alternatively, the sensing electrode 106 may detect another component of nitrogen oxide (NO_{X}) such as nitrogen dioxide (NO₂).

Various types of sensing electrodes 106 may be used in different embodiments of the sensing apparatus 100. In one embodiment, the sensing electrode 106 is implemented using a mixed potential technology. In some embodiments, the sensing electrode 106 is similar to an exhaust gas sensor. In other embodiments, the sensing apparatus 100 includes multiple sensing electrodes 106 such as an oxygen sensor, a NO_{X} sensor, or another type of sensor. Various exemplary sensor electrodes 106 are described in more detail in U.S. Pat. No. 6,764,591, issued Jul. 20, 2004, and U.S. Pat. No. 6,843,900, issued Jan. 18, 2005, both of which are incorporated by reference herein in their entirety. Additionally, other exemplary sensor electrodes 106 are described in more detail in U.S. patent application Ser. No. 11/182,278, filed Jul. 14, 2005, which is incorporated by reference herein in its entirety.

The sensing electrode 106 generates an electrode signal (e.g., a voltage signal) in response to detecting a corresponding component of NO_{X}, or another gas, depending on the type of sensing electrode 106 that is implemented. Alternatively, if two or more sensing electrodes 106 are implemented, each sensing electrode 106 may generates its own electrode signal. For example, an embodiment of the sensing apparatus 100 which implements a NO sensing electrode 106 and an oxygen sensing electrode 106 may use two electrode signals-one generated by the NO sensing electrode 106 and the other generated by the oxygen sensing electrode 106. Once the electrode signal is generated, the exhaled breath exits the sensing apparatus 100 through the outlet 108.

The electrode signal generated by the sensing electrode 106 is subsequently transmitted to the electronic circuitry 110, which determines a level of NO in the exhaled breath. In one embodiment, the electronic circuitry 110 converts the electrode signal to a measured NO reading that can be displayed on the display 112. Alternatively, the electronic circuitry 110 may provide another type of indicator, scale, or message to the display 112 to be conveyed to a user. For example, the display 112 may display a quantitative indicator such as a NO measurement reading. In another embodiment, the display 112 may display a qualitative indicator such as a message to convey the presence and/or severity (e.g., low or high NO levels) of asthma. Other exemplary types of messages displayed by the display 112 may include an indication that medication should be obtained, suggested dosages, prescription information, treatment instructions, or instructions to contact a physician or seek emergency care.

Thus, embodiments of the sensing apparatus 100 allow for measurements and/or readings of breath components with normal exhalation and without sustained exhalation. In other words, the sensing apparatus 100 can take readings or measure breath components with small volumes of exhaled breath, without the need for holding chambers and the like. Accordingly, the sensing apparatus 100 can use a patient's natural breathing pattern to take NO measurements without the use of additional exhalation force over a sustained period of time.

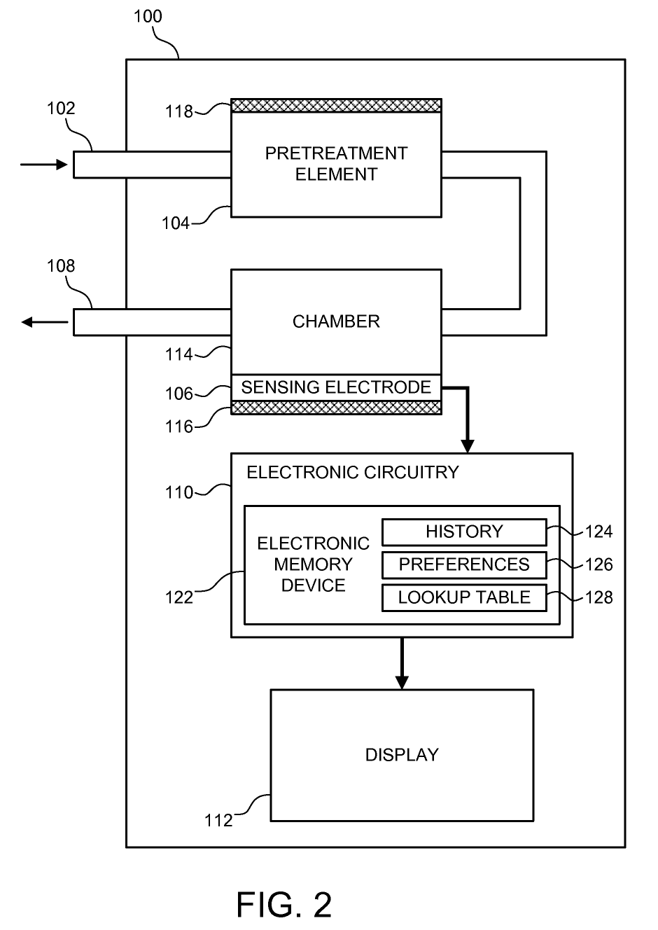

FIG. 2 depicts a schematic block diagram of a more detailed embodiment of the sensing apparatus 100 of FIG. 1. In addition to the components described above, the sensing apparatus 100 of FIG. 2 also includes a chamber 114, an electrode heater 116, a catalyst heater 118, and an electronic memory device 122.

It should be noted that FIG. 2 shows a pretreatment element 104, generally, compared to the more specific catalyst 104 of FIG. 1. While the pretreatment element 104 may be a catalyst, other types of pretreatment elements 104 may be implemented that are not catalysts. Therefore, references to the catalyst 104 in this description should be understood to be exemplary of the pretreatment element 104, and not limiting of the scope of the several embodiments of the sensing apparatus 100.

It should also be noted that the chamber 114 is not necessarily a holding chamber to hold the exhaled breath for a specific amount of time. Rather, the chamber 114 may or may not be a holding chamber. In some embodiments, the chamber 114 is simply a conduit or passageway for the exhaled breath to pass through as it travels from the pretreatment element 104 to the outlet 108, for example, while the sensing electrode 106 generates the corresponding electrode signal. In one embodiment, the volume of the chamber 114 is approximately 300 cc. In another embodiment, the volume of the chamber 114 is less than about 50 cc. Alternatively, the volume of the chamber 114 is less than about 20 cc. In one embodiment, the chamber 114 is less than 5 cc. In another embodiment, the chamber 114 is less than 2 cc. These volumes may also be applicable to the entire sensing apparatus 100.

In one embodiment, the electrode heater 116 preheats the sensing electrode 106 to a predetermined temperature prior to operation of the sensing apparatus 100. Alternatively, the electrode heater 116 may preheat the sensing electrode 106 to an operating temperature range. The predetermined temperature or the operating temperature range depends on the type of sensing electrode 106 that is used. For example, the electrode heater 116 may preheat the sensing electrode 106 to an operating temperature range of about 450-550° C. for a sensing electrode 106 configured to detect NO in the exhaled breath. As another example, the electrode heater 116 may preheat the sensing electrode 106 to an operating temperature range of about 700-800° C. for a sensing electrode 106 configured to detect oxygen in the exhaled breath. As another example, the electrode heater 116 may preheat the sensing electrode 106 to an operating temperature range of about 300-1000° C. for other types of sensing electrodes 106. Other temperatures and temperature ranges may be used, as explained in the references incorporated above, depending on the type of sensing electrode 106 implemented. In some embodiments, multiple electrode heaters 116 may be implemented for multiple corresponding sensing electrodes 106. The amount of time allocated or consumed to preheat the sensing electrode 106 depends on the type of sensing electrode 106 and electrode heater 116 implemented, as well as the general construction of the sensing apparatus 100. In a similar manner, the catalyst heater 118 heats the pretreatment element 104 such as a catalyst to a predetermined temperature, or within a temperature range, to enhance the effectiveness of the pretreatment element 104.

In one embodiment, the electronic circuitry 110 includes various electronic components, including the electronic memory device 122. Different embodiments of the electronic circuitry 110 may implement the electronic memory device 122 using different types of data memory or data storage technology, including but not limited to read only memory (ROM), random access memory (RAM), flash memory, removable memory media, and so forth. Although not shown, other electronic components may be implemented in the electronic circuitry 110. For example, some embodiments of the electronic circuitry 110 include a processor such as a general purpose processor, a digital signal processor (DSP), a microprocessor, a field programmable gate array (FPGA), or an application specific integrated circuit (ASIC). It should be noted that the implementation of the electronic circuitry 110, including the electronic memory device 122, is not limited to a particular configuration, arrangement, or technology.

In one embodiment, the electronic memory device 122 is configured to store various types of data. For example, the electronic memory device 122 may store historical data 124, user preferences 126, and a lookup table 128. Other embodiments may store additional data or other types of data. In one embodiment, the historical data 124 include data to describe historical NO levels for a particular user. In another embodiment, the user preferences 126 include default and/or user-specific settings for the sensing apparatus 100. For example, a user may indicate whether the user prefers to receive messages about quantitative or qualitative evaluations, or both, of the user's NO levels.

In one embodiment, the lookup table 128 stores data to translate between a digital signal, which is associated with the electrode signal, and a NO value corresponding to the digital signal. For example, where the sensing electrode 106 generates an analog voltage signal as the electrode signal, and a digital-to-analog converter (DAC) (not shown) converts the electrode signal to a digital signal, which the electronic circuitry 110 may use to index the lookup table 128 to determine what NO level corresponds to the electrode signal.

It should be noted that the type of lookup table 128 implemented may depend on the type of electrode signal (or signals) generated by the sensing electrode 106 (or sensing electrodes 106). For example, where a NO sensing electrode 106 is implemented, an embodiment of the lookup table 128 outputs a NO measurement level based on the digital signal corresponding to the analog NO electrode signal. Alternatively, where a NO₂ sensing electrode 106 is implemented, an embodiment of the lookup table 128 outputs a NO measurement level based on the digital signal corresponding to the analog NO₂ electrode signal. In another embodiment, where both NO and oxygen sensing electrodes 106 are implemented, an embodiment of the lookup table 128 outputs a NO measurement level based on a combination (e.g., ratio) of the digital signals corresponding to the analog NO and oxygen electrode signals. It should be noted that such combinations of multiple signals (e.g., NO and oxygen electrode signals) may be combined in either the analog domain or the digital domain.

Moreover, although some embodiments of the lookup table 128 are used to output NO measurement levels directly, other embodiments of the lookup table 128 may be used to output qualitative indicators, rather than quantitative indicators. Furthermore, other embodiments of the electronic circuitry 110 may use another technology instead of the lookup table 128 stored in the electronic memory device 122.

Although several components of the sensing apparatus 100 are shown and described above with reference to FIGS. 1 and 2, other embodiments of the sensing apparatus may include fewer or more components. For example, some embodiments may include additional circuitry such as a power supply to provide power to some or all of the components, or an interface unit to allow the sensing apparatus 100 to interface with other electronic devices. An interface unit may include circuitry for wired or wireless communications, for example, with a host computer using any type of standardized or proprietary communication protocol. Other embodiments of the sensing apparatus 100 may include additional user interface tools such as an audible feedback circuit (e.g., a speaker), visual indicators (e.g., a light emitting diode (LED)), tactile buttons, an alphanumeric keypad, and so forth.

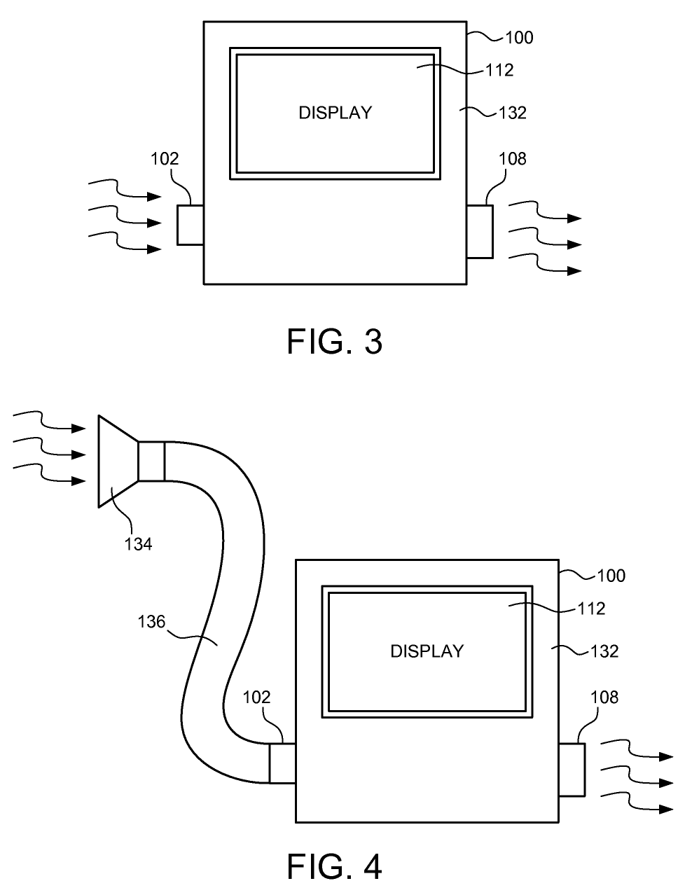

FIG. 3 depicts a schematic diagram of another embodiment of the sensing apparatus 100 of FIG. 1. The illustrated sensing apparatus 100 includes a housing 132 with a display 112, an inlet 102, and an outlet 108. As explained above, the inlet 102 receives exhaled breath (indicated by the inbound arrows) for processing, and the outlet 108 exhausts the exhaled breath (indicated by the outbound arrows) after the exhaled breath passes through the sensing apparatus 100. In one embodiment, the inlet 102 is configured to facilitate direct contact with a user's mouth and/or nose, so as to form a substantial seal around the inlet 102 and thereby maximize the amount of exhaled breath that is directed into the sensing apparatus 100. In another embodiment, the inlet 102 may be configured to receive the exhaled breath without direct contact with a user's mouth or nose. Although some of the exhaled breath will likely escape prior to entering the inlet 102, in the absence of direct contact, embodiments of the sensing apparatus 100 are sensitive enough to operate accurately using a relatively small volume of exhaled air.

FIG. 4 depicts a schematic diagram of another embodiment of the sensing apparatus 100 of FIG. 1, including a receiver 134 and a conduit 136 to direct the exhaled breath into the inlet 102 of the sensing apparatus 100. Like the inlet 102 described above, the receiver 134 may be configured to facilitate direct contact with a user's mouth. Alternatively, the receiver 134 may be configured to facilitate direct contact with a user's nose, or a combination of the user's mouth and nose. In other embodiments, the receiver 134 may be configured to receive the exhaled breath without direct contact with a user's mouth or nose. Additionally, the shape of the receiver 134 may vary depending on the breathing application for which the receiver 134 is used. Some embodiments of the receiver may be shaped to facilitate normal breathing by the user. Other embodiments may be shaped to facilitate active blowing, as opposed to normal breathing, by the user.

The exhaled breath received by the receiver 134 is then conducted to the inlet 102 of the sensing apparatus 100 through the conduit 136. In one embodiment, the conduit 136 is a tube that does not absorb NO, or absorbs very little NO. For example, the conduit 136 may have an interior surface material such as TEFLON or silicone to deflect substantially all of the NO_{X} in the exhaled breath. Alternatively, the conduit 136 may have another material on the interior surface. Additionally, the NO_{X}-resistant material may be integral to the conduit 136 or may be coated or otherwise applied on the interior surface of the conduit 136.

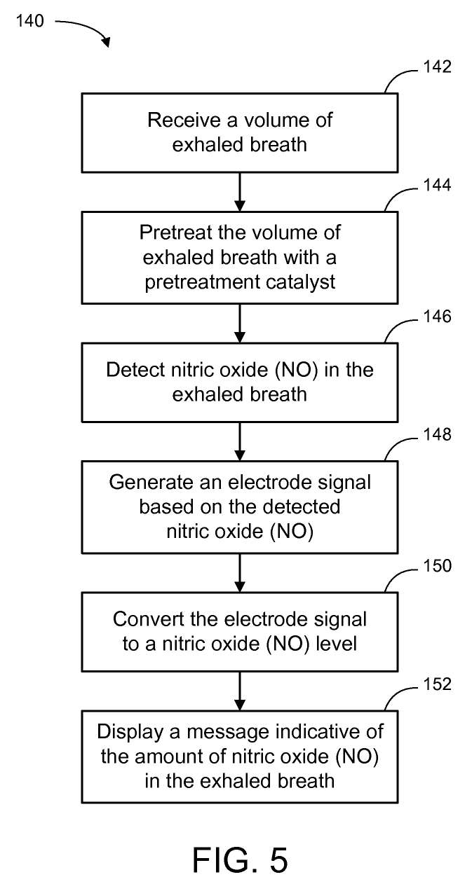

FIG. 5 depicts a schematic flow chart diagram of one embodiment of a method 140 to determine a level of NO in the exhaled breath by detecting NO in the pretreated exhaled breath. Some embodiments of the method 140 may be implemented in conjunction with the sensing apparatus 100 described above. However, other embodiments of the method 140 may be implemented in conjunction with another type of sensing apparatus.

In the illustrated method 140, the sensing apparatus 100 receives 142 a volume of exhaled breath from a source such as a patient. In one embodiment, the exhaled breath is received through the inlet 102. In a further embodiment, the exhaled breath is first received through the receiver 134 and the conduit 136. The pretreatment element 104 then pretreats 144 the exhaled breath, for example, with a pretreatment catalyst, as described above. In one embodiment, the pretreatment element 104 is porous and the exhaled breath flows through the pretreatment element 104 to the sensing electrode 106.

In one embodiment, the pretreated air is specifically conducted to a chamber 114. The sensing electrode 106 is coupled to the chamber 114 and detects 146 NO in the pretreated breath. Upon detection of NO in the pretreated breath, the sensing electrode 106 generates 148 an electrode signal based on the detected NO. In one embodiment, the sensing electrode 106 transmits the electrode signal to the electronic circuitry 110, which converts 150 the electrode signal to a NO level. The sensing apparatus 100 then displays 152 a message indicative of the amount of NO in the exhaled breath. As described above, the displayed message may be a quantitative indicator, a qualitative indicator, or a combination of quantitative and qualitative indicators. The illustrated method 140 then ends.

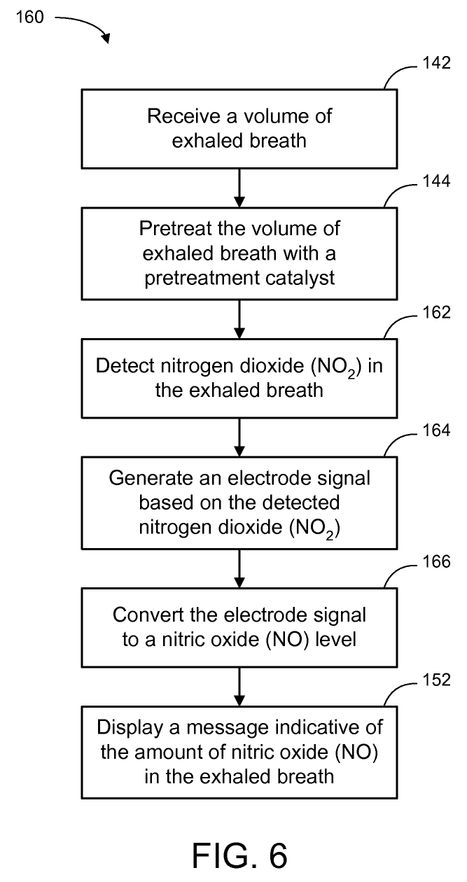

FIG. 6 depicts a schematic flow chart diagram of one embodiment of a method 160 to determine a level of NO in the exhaled breath by detecting NO₂ in the pretreated exhaled breath. In contrast to the method 140 shown in FIG. 5, the method 160 detects NO₂ and uses the detected NO₂, rather than detected NO, to determine the level of NO in the exhaled breath. Some embodiments of the method 160 may be implemented in conjunction with the sensing apparatus 100 described above. However, other embodiments of the method 160 may be implemented in conjunction with another type of sensing apparatus.

It should be noted that the operations of receiving 142 a volume of exhaled breath, pretreating 144 the exhaled breath, and displaying 152 a message to the user are substantially similar to the corresponding operations in the method 140 of FIG. 5. Hence, a further description of these operations is not provided here. However, instead of detecting NO in the exhaled breath, the sensing electrode 106 detects 162 NO₂ in the exhaled breath. In some embodiments, the sensing electrode 106 may be more sensitive to NO₂ than to NO. Thus, the pretreatment operation 144 may be used to substantially convert NO in the exhaled breath to NO₂, and by measuring NO₂, one can indirectly measure the amount of NO in the exhaled breath. This may increase the accuracy of some embodiments of the sensing apparatus 100.

Upon detection of NO₂ in the pretreated breath, the sensing electrode 106 generates 164 an electrode signal based on the detected NO₂. In one embodiment, the sensing electrode 106 transmits the electrode signal to the electronic circuitry 110, which converts 166 the electrode signal to a NO level. The remaining operations of the method 160 are similar to the operations described above with reference to the method 140 of FIG. 5.

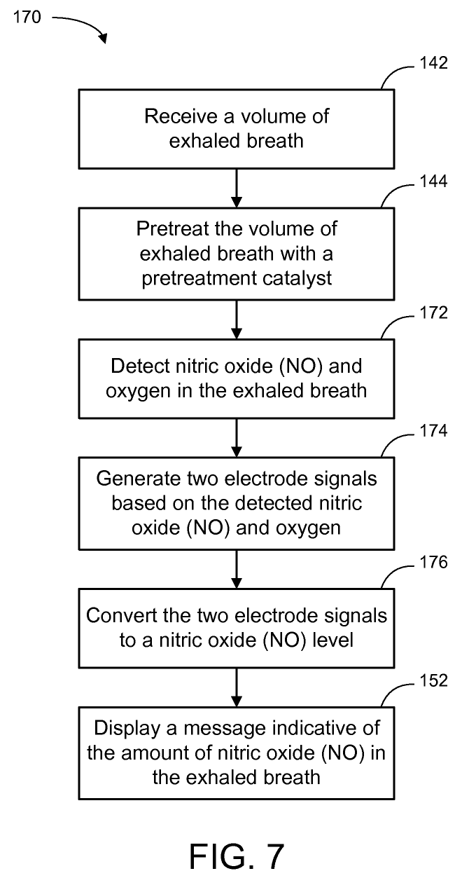

FIG. 7 depicts a schematic flow chart diagram of one embodiment of a method 170 to determine a level of NO in the exhaled breath by detecting NO and oxygen in the pretreated exhaled breath. In contrast to the methods 140 and 160 shown in FIGS. 5 and 6, the method 170 detects both NO and oxygen, and uses the detected NO and oxygen, rather than detected NO₂ or just detected NO, to determine the level of NO in the exhaled breath. Some embodiments of the method 170 may be implemented in conjunction with the sensing apparatus 100 described above. However, other embodiments of the method 170 may be implemented in conjunction with another type of sensing apparatus.

It should be noted that the operations of receiving 142 a volume of exhaled breath, pretreating 144 the exhaled breath, and displaying 152 a message to the user are substantially similar to the corresponding operations in the method 140 of FIG. 5. Hence, a further description of these operations is not provided here. However, instead of just detecting NO in the exhaled breath, the sensing electrode 106 detects 172 both NO and oxygen in the exhaled breath. In one embodiment, the sensing apparatus 100 includes at least two sensing electrodes 106 to individually detect the presence of NO and oxygen components in the exhaled breath. Upon detection of NO and oxygen components in the pretreated breath, the sensing electrodes 106 generate 174 electrode signals based on the detected NO and oxygen. In one embodiment, the sensing electrodes 106 transmit the corresponding electrode signals to the electronic circuitry 110, which converts 176 the electrode signals, or a combination of the electrode signals, to a NO level. The remaining operations of the method 170 are similar to the operations described above with reference to the method 140 of FIG. 5.

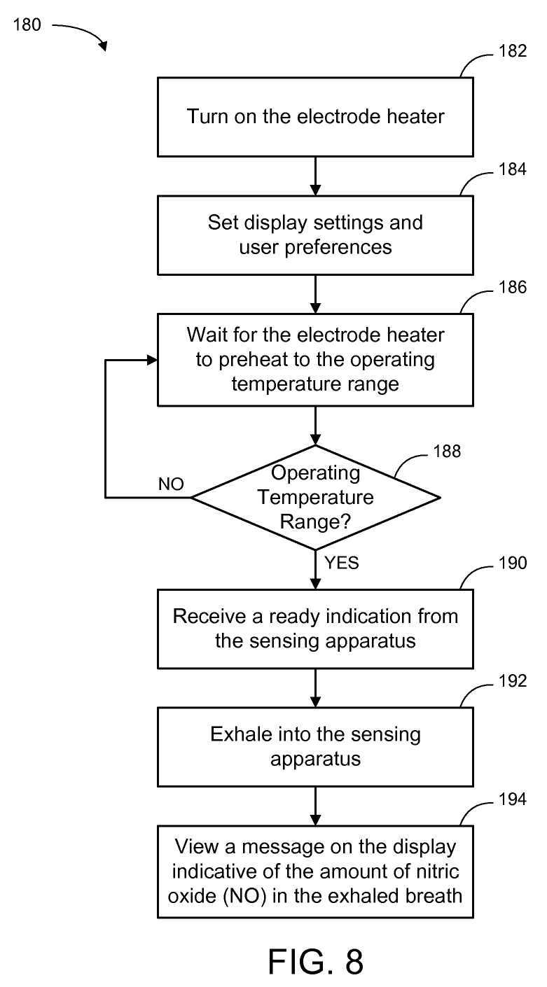

FIG. 8 depicts a schematic flow chart diagram of one embodiment of a method 180 for user interaction with an embodiment of the sensing apparatus 100 of FIG. 1. Some embodiments of the method 180 may be implemented in conjunction with the sensing apparatus 100 described above. However, other embodiments of the method 180 may be implemented in conjunction with another type of sensing apparatus.

In the illustrated method 180, the user turns on the sensing apparatus 100, including turning on 182 the electrode heater 116. This allows the electrode heater 116 to preheat, as described above. The user also may set 184 display settings or other user preferences upon initiation of the sensing apparatus 100. The user then waits 186 for the electrode heater 116 to preheat to the operating temperature range of the sensing electrode 106. In some embodiments, it may take only a few minutes for the electrode heater 116 to preheat the sensing electrode 106. Once the sensing electrode 106 is determined 188 to be within the operating temperature range, the user may receive 190 a ready indication from the sensing apparatus 100. For example, the sensing apparatus 100 may display a ready indicator on the display 112, turn on a ready indicator LED, generate an audible ready tone, or implement another type of ready indicator.

After the sensing apparatus 100 is ready and the sensing electrode 106 is preheated, the user then exhales 192 into the sensing apparatus 100. In one embodiment, the user exhales directly into the inlet 102 or the receiver 134. The sensing apparatus 100 then performs as described above, and the user views 194 a message on the display 112. In one embodiment, the message is a quantitative indicator to indicate a level of NO in the exhaled breath. Alternatively, the message may be a qualitative indicator to provide a qualitative evaluation or assessment of the user's level of NO in the exhaled breath. The illustrated method 180 then ends.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A sensing apparatus to measure nitric oxide (NO) in exhaled breath, the sensing apparatus comprising:
an inlet to receive the exhaled breath;
a pretreatment element to receive the exhaled breath from the inlet and to condition a chemical characteristic of the exhaled breath; and
a sensing electrode coupled to a chamber within the sensing apparatus, the chamber to receive the pretreated exhaled breath from the pretreatment element, the sensing electrode to detect a component of nitrogen oxide (NO_{X}) in the exhaled breath.

2. The sensing apparatus of claim 1, wherein the sensing electrode is further configured to detect NO in the exhaled breath.

3. The sensing apparatus of claim 1, further comprising another sensing electrode coupled to the chamber, the other sensing electrode to detect an oxygen component in the exhaled breath.

4. The sensing apparatus of claim 1, wherein the pretreatment element comprises an oxidation catalyst to oxidize hydrocarbons in the exhaled breath.

5. The sensing apparatus of claim 1, wherein the pretreatment element comprises an oxidation catalyst to oxidize ammonia in the exhaled breath to nitrogen and H₂O.

6. The sensing apparatus of claim 1, further comprising:
a receiver to receive the exhaled breath when the receiver is in close proximity to a source of the exhaled breath;
a conduit coupled between the receiver and the inlet, the conduit to direct the exhaled breath from the receiver to the inlet, the conduit comprising an interior surface material configured to deflect substantially all of the nitrogen oxide (NO_{X}) in the exhaled breath; and
an outlet to exhaust the exhaled breath from the sensing apparatus after the detection of the NO_{X} in the exhaled breath.

7. The sensing apparatus of claim 1, further comprising an electrode heater thermally coupled to the sensing electrode, the electrode heater to preheat the sensing electrode to within an operating temperature range of about 450-550° C.

8. The sensing apparatus of claim 1, further comprising electronic circuitry coupled to the sensing electrode, the electronic circuitry to receive an electrode signal from the sensing electrode and to determine a level of NO in the exhaled breath according to the electrode signal from the sensing electrode.

9. The sensing apparatus of claim 8, wherein the sensing electrode is configured to detect nitrogen dioxide (NO₂) received from the pretreatment element, the electrode signal indicative of a level of the detected NO₂, the electronic circuitry further configured to convert the electrode signal indicative of the level of the detected NO₂ to an electronic signal indicative of the level of NO in the exhaled breath.

10. The sensing apparatus of claim 8, wherein the electronic circuitry comprises an electronic memory device to store a lookup table, the lookup table comprising a plurality of electrode signal values and a corresponding plurality of NO values.

11. The sensing apparatus of claim 8, further comprising a display device coupled to the electronic circuitry, the display device to display a message to a user, the message indicative of the level of NO in the exhaled breath.

12. The sensing apparatus of claim 11, wherein the message comprises a quantitative indicator or a qualitative indicator associated with the level of NO in the exhaled breath.

13. The sensing apparatus of claim 1, wherein the chamber comprises a volume of less than about 300 cubic centimeters.

14. The sensing apparatus of claim 1, wherein the chamber comprises a volume of less than about 50 cubic centimeters.

15. The sensing apparatus of claim 1, wherein the chamber comprises a volume of less than about 20 cubic centimeters.

16. The sensing apparatus of claim 1, wherein the chamber comprises a volume of less than about 5 cubic centimeters.

17. The sensing apparatus of claim 1, wherein the chamber comprises a volume of less than about 2 cubic centimeters.

18. The sensing apparatus of claim 1, further comprising a volume of less than about 300 cubic centimeters.

19. The sensing apparatus of claim 1, further comprising a volume of less than about 50 cubic centimeters.

20. The sensing apparatus of claim 1, further comprising a volume of less than about 20 cubic centimeters.

21. The sensing apparatus of claim 1, further comprising a volume of less than about 5 cubic centimeters.

22. The sensing apparatus of claim 1, further comprising a volume of less than about 2 cubic centimeters.

23. A method for measuring nitric oxide (NO) in exhaled breath, the method comprising:
receiving the exhaled breath;
pretreating a chemical characteristic of the exhaled breath;
conducting the pretreated exhaled breath to a sensing electrode; and
detecting a component of nitrogen oxide (NO_{X}) in the exhaled breath.

24. The method of claim 23, further comprising detecting the component of nitrogen oxide (NO_{X}) in the exhaled breath by detecting NO in the exhaled breath.

25. The method of claim 23, further comprising pretreating the chemical characteristic of the breath by oxidation of a component of the exhaled breath.

26. The method of claim 23, further comprising preheating the sensing electrode to within an operating temperature range of about 450-550° C.

27. The method of claim 23, further comprising:
generating an electrode signal at the sensing electrode;
determining a level of NO in the exhaled breath based on the electrode signal; and
communicating to a user an indication of the level of NO in the exhaled breath.

28. A sensing apparatus to evaluate nitric oxide (NO) in exhaled breath, the sensing apparatus comprising:
means for conducting the exhaled breath to a chamber within the sensing apparatus;
means for generating an electrode signal in response to detection of a component of nitrogen oxide (NO_{X}) in the exhaled breath; and
means for determining a level of NO in the exhaled breath based on the electrode signal.

29. The sensing apparatus of claim 28, further comprising means for conveying a quantitative indicator to a user, the quantitative indicator indicative of the level of NO in the exhaled breath.

30. The sensing apparatus of claim 28, further comprising means for conveying a qualitative indicator to a user, the qualitative indicator indicative of the level of NO in the exhaled breath.
